(19) United States
(12) Patent Application Publication
(10) Pub. No.: US 2008/0184475 A1
(43) Pub. Date: Aug. 7, 2008

(54) ILLUMINATED GRAB BAR

(75) Inventors: Abbie J. W. Sladick, Naples, FL (US); Ashley Armstrong, Naples, FL (US)

Correspondence Address: HAHN LOESER & PARKS, LLP, One GOJO Plaza, Suite 300, AKRON, OH, 44311-1076, US

(73) Assignee: GREAT GRABZ, LLC, Naples, FL (US)

(21) Appl. No.: 12/027,256

(22) Filed: Feb. 6, 2008

Related U.S. Application Data
(60) Provisional application No. 60/888,400, filed on Feb. 6, 2007.

(51) Int. Cl. A47K 3/022; A47H 1/02; A47H 1/14; F21S 8/00

(52) U.S. Cl. 4/576.1; 211/105.2; 248/251; 362/147

(57) ABSTRACT

A combination grab or article support bar and light source is may comprise an elongated bar body, wherein the bar body is translucent or transparent; means for attaching the bar body to a wall; and means for lighting at least partially located within the bar body. The means for lighting may comprise fiber optic lighting, Light-Emitting Diode (LED) lighting, or any of a plurality of other means for lighting such as fluorescent or incandescent lights.

### CROSS-REFERENCE TO RELATED APPLICATIONS

This application claims the benefit of U.S. provisional patent application Ser. No. 60/888,400 under 35 U.S.C. §119(e), filed on Feb. 6, 2007, which is hereby incorporated by reference.

### FIELD OF THE INVENTION

The present invention relates to a grab bar and, more particularly, to a grab bar that provides a source of illumination.

### BACKGROUND OF THE INVENTION

Each year, many people of all ages are injured from slip and falls. Grab bars generally are useful to help prevent people from falling in an around a bathroom area. For example, grab bars in a home assist in the safe transfer of people in and out of a bathtub or shower area. Grab bars further act as a balancing assist for people as they are in the shower or when they are drying in the adjacent bath area. Additionally, grab bars may be placed in locations such that they are useful for holding bath items, such as towels and toilet paper.

Aside from the use of grab bars in a residence, hotels and motels install grab bars in both handicap and standard rooms. The surroundings of a hotel room are often unfamiliar to the occupant, and thus a person is even more likely to slip and fall in the hotel room versus the person's home.

Grab bars that are intended as safety devices must be able to bear the weight of the person holding or grabbing the bar Furthermore, the grab bar should preferably be located in a suitable position and provide high visibility so that it can be located and grabbed quickly.

Standard grab bars are typically constructed out of a color and material that will blend into the background. Their functional design is based on the need for weight bearing and stability only. They do not address the need for visibility in low light areas or for people who do have vision problems.

Therefore, there is a need for a bar that has illumination. The illumination will make the grab bar more visible in low light and situations. This visual orientation will assist in giving the user a surer grip on the bar in proper location. The light may optionally provide ambient light a dark space which may have tripping hazards such as bath mats and obstacles in the area.

### SUMMARY OF THE INVENTION

One or more embodiments of an illuminated grab bar are thought to improve upon existing grab bar design. In this regard, an illuminated bar may be usable in both wet and dry situations. The lights may come in varying colors and/or changeable colors, adding to the chromatherapy health benefits.

In one embodiment, a combination grab or article support bar and light source is disclosed that comprises an elongated bar body, wherein the bar body is translucent or transparent; means for attaching the bar body to a wall; and means for lighting at least partially located within the bar body. The means for lighting may comprise fiber optic lighting, Light-Emitting Diode (LED) lighting, or any of a plurality of other means for lighting such as fluorescent or incandescent lights.

In another embodiment, a combination grab bar and light is disclosed that comprises a translucent bar body; and a light source at least partially located within the bar body, wherein, the grab bar is capable of supporting the weight of a person.

In yet another embodiment, a method of providing light for a room is disclosed that comprises providing a support bar selected from the group consisting of grab bars, towel bars, and toilet paper holders; wherein the support bar is at least partially translucent or transparent; and placing a light source at least partially inside the support bar such that light shines through the bar and provides light for the room.

### BRIEF DESCRIPTION OF THE DRAWINGS

FIG. 1 is a side view of an embodiment of an illuminated grab bar assembly.

FIG. 2 is a top plan view of the illuminated grab bar assembly of FIG. 1.

FIG. 3 is longitudinal cross-sectional view of an end portion of a bar, shown without a fixture attached and without an end cap attached.

FIG. 4 is an end view of the bar as illustrated in FIG. 3.

FIG. 5 is a cross-sectional view of a fixture that may be used in attaching a bar to a wall, illustrated from the perspective of line 5-5 of FIG. 2, and not attached to a bar.

FIG. 6 is a cross-sectional view of the fixture of FIG. 5, illustrated from the perspective of line 6-6 of FIG. 2, and not attached to a bar.

FIG. 7 is a bottom view of the fixture of FIGS. 5-6.

FIG. 8 is a side cross-sectional view of a mounting plate.

FIG. 9 is a top plan view of the mounting plate of FIG. 8.

FIG. 10 is a schematic representation of a grab bar installed on a wall.

FIGS. 11A-11B illustrate a second embodiment of an illuminated bar assembly in the form of a toilet paper holder.

FIGS. 12A-12B illustrate a third embodiment of an illuminated bar assembly in the form of a short straight grab bar.

FIGS. 13A-13B illustrate a fourth embodiment of an illuminated bar assembly in the form of a long straight grab bar.

FIGS. 14A-14B illustrate a fifth embodiment of an illuminated bar assembly in the form of a short curved grab bar.

FIGS. 15A-15B illustrate a sixth embodiment of an illuminated bar assembly in the form of a long curved grab bar.

### DETAILED DESCRIPTION OF THE INVENTION

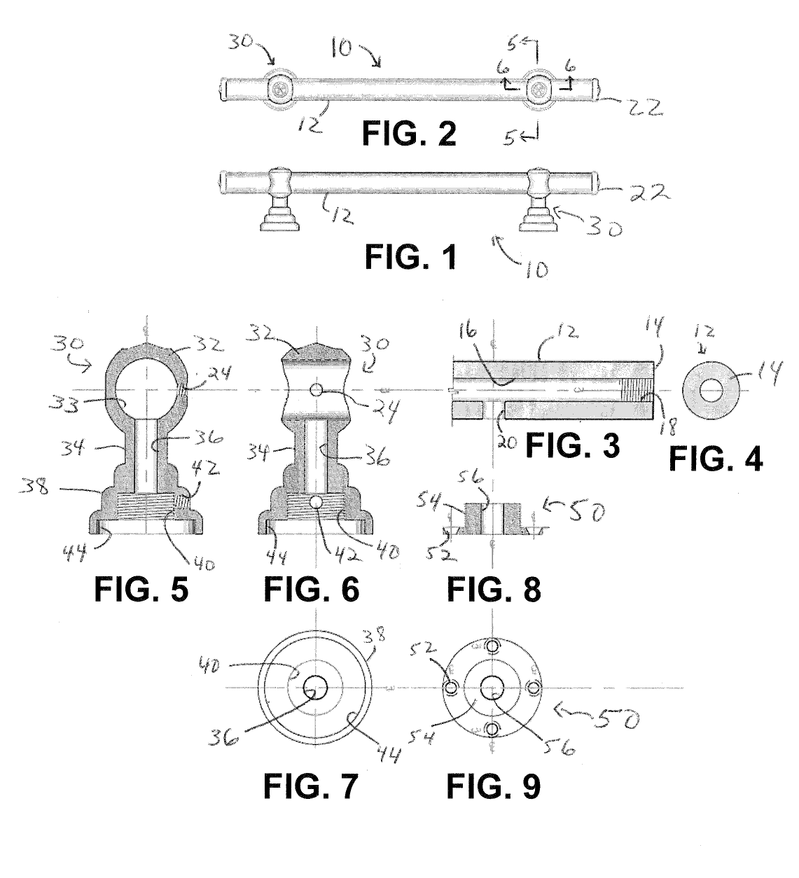

A preferred embodiment of an illuminated grab bar assembly, generally identified by reference number 10, is illustrated in the FIGS. 1-9. Illuminated grab bar assembly 10 may comprise elongated bar body 12, fixtures 30, mounting plates 50, and light source 70 with power supply.

Elongated bar 12 may include two ends 14 and a central bore 16. The central bore 16 may terminate in threaded portions 18 that receive an end cap 22. In one embodiment, end caps 22 are removable and replaceable via a threaded protrusion on the end cap 22 that is threadedly attachable to threaded portion 18 in bar 12. The outer or displayed portion of end caps 22 may be decorative in nature such that the owner of the bar assembly 10 may somewhat customize it based on the taste of the owner.

In some embodiments, the bar is manufactured from a material that is translucent or transparent. In one embodiment, the bar comprises a translucent acrylic. However, it is contemplated that the bar may be manufactured from any suitable material, such as any of a plurality of suitable polymers that are strong enough to support the weight of a person yet allow light from the interior of the bar 12 to shine through the bar 12. Bar 12 may additionally comprise at least one aperture 20 (FIG. 3) that receives at least a portion of a light means, such as fiber optic cable, or a power supply cord. In one or more embodiments, the aperture 20 may be located near an end of the bar 12 at a location suitable to be overlaid by a fixture 30.

Similar to standard grab bars, grab bar assembly 10 may further comprises two fixtures that aid in attaching the bar 12 to a wall 60 or other support structure. In some embodiments, at least one of the fixtures may comprise fixture 30. Fixtures 30 may comprise portion 32 having aperture 33 that receives a bar 12 therethrough. Fixture 30 may further comprise a neck portion 34, and base portion 38 comprising a recess 44 extending inward from the bottom of base 38 and threaded recess 40 extending inward from recess 44. As illustrated in FIG. 5, neck portion 34 may comprise aperture 36 extending therethrough that is in communication with aperture 33 at one end and threaded aperture 44 on the other end. When fixture 30 is properly installed on bar 12 overlaying aperture 20, aperture 36 in fixture 30 aligns with aperture 20 in bar 12.

Recess 44 and threaded recess 40 aid in attaching fixture 30 to a wall 60 or other support surface. In some embodiments, a mounting plate may first attach to the wall 60 on one end and to fixture 30 on its other end.

One embodiment of a mounting plate 50 is illustrated in FIGS. 8-9. Mounting plate 50 may comprise a generally circular body with apertures 52 that receive screws or other fasteners that affix mounting plate 50 to a wall. Mounting plate 50 may further comprise threaded projection portion 54 having aperture 56 extending through the projection and through the body of the mounting plate 50. The threaded projection 54 may have external threads that are complementary to internal threads of recess 40 in fixture 30.

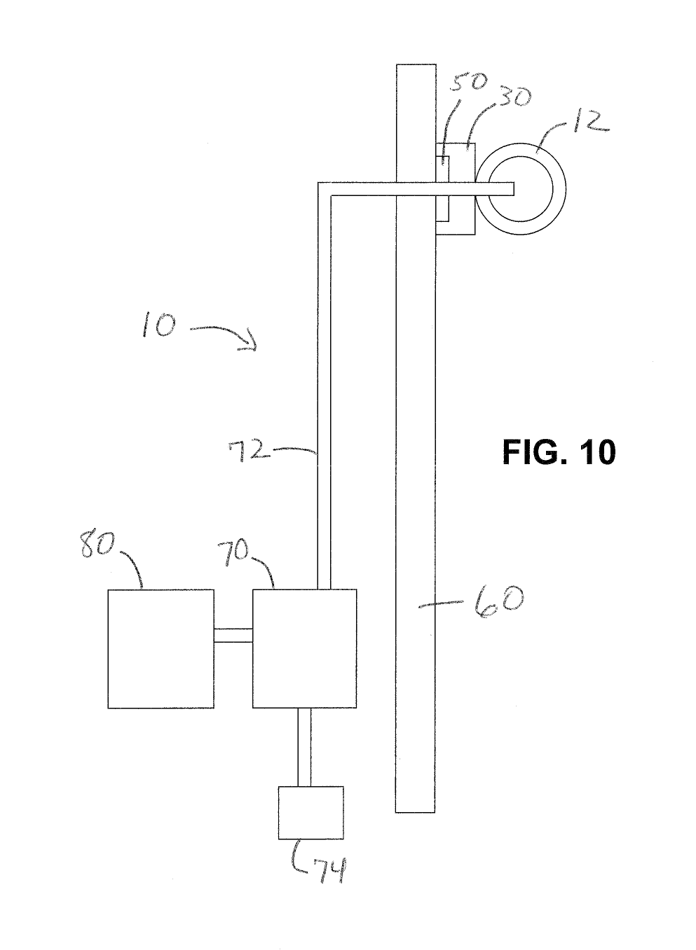

Illuminated bar assembly 10 may further comprise a light source that shines light from the interior of bar 12. The light source may comprise a fiber optic light system, an LED light system, or any of a plurality of light systems that are suitable for use in a grab bar. In one embodiment, as illustrated in FIG. 10, a light source 70 such as a fiber optic light source may be located at a location spaced from bar 12, although it is also contemplated that the entire light source is located within bar 12. The light source 70 may be connected to a suitable power supply 80 such as alternating current found in a home's electrical system, or a battery. The light source 70 may transfer light to the bar 12 by one or more fiber optic cables 72, which extend through wall 60, mounting plate 50, fixture 30, and finally through aperture 20 into bar 12. It is apparent that cables 72 may only be required to be inserted through one fixture 30 of the two fixtures that hold up the bar 12.

Alternatively, one or more LED lights may be located within bar 12. In such an embodiment, bar 12 may comprise one or more electrical contacts on an outer end that contact one or more corresponding electrical contacts on a fixture. The fixture contacts may be connected to a power supply, such as an AC or DC power supply. If electrical power is going into the bar 12, one or more insulators or o-rings may be used in aperture 33 in fixture 30 to prevent water and moisture was reaching the electrical system. It is contemplated that different color LED may be used, such that the owner of the bar assembly 10 may choose a particular color of light to shine through bar 12. To that end, the LED light system may be connected to a board or computing device such that it that can be programmed to select different colors of lights at predetermined times, such as randomization of light color or light color that changes every hour once or more per day.

With any of the embodiments, it is contemplated that the bar assembly 10 may be connected to a switch 74 such as a wall switch so that the user can turn the light on and off.

To install a bar assembly 10, the light source 70 is first installed in a suitable location (if located externally of bar 12) and connected to a power source 80. Fiber optic cables can be run from the light source through one or both apertures in a wall 60 or other support structure. In this example, the cables 72 are fed through only one of the wall apertures. After feeding cables 72 through aperture 56 in one of the mounting plates 50, the mounting plates 50 may then be affixed to a wall 60 or other support structure by one or more fasteners that are inserted through apertures 52 and into the wall 60 or other support structure. Thereafter, the cables are fed through aperture 36 in one of the fixtures 30 and the base portions 38 of fixtures 30 are mounted to respective mounting plates 50 via a threaded connection 40, 54. A set screw may then be tightened in one or both set screw apertures 42 in the fixtures 30 to fixedly secure the fixtures 30 to mounting plate 50.

Next, the cables 72 may be fed into aperture 20 in bar 12 and the bar 12 may be adjusted relative to portions 32 of fixture 30 so that apertures(s) 20 are covered by portion 32 of fixture 30. Thereafter, a set screw may be tightened within each set screw aperture 24 to secure the bar 12 longitudinally relative to fixture 30.

In an alternative embodiment, as stated previously, an external surface of the bar 12 analogous to aperture 20 may comprise electrical connections. If so, the bar 12 may be installed by sliding the bar 12 through apertures 33 in fixtures 30 until the electrical contacts engage corresponding contacts in fixture 30. It is contemplated that in one embodiment, the contacts in the fixture may be located near the opening of aperture 36. Once the bar 12 is positioned such that the electrical contacts are engaged, the set screws can be tightened to secure the bar 12 longitudinally relative to the fixture 30.

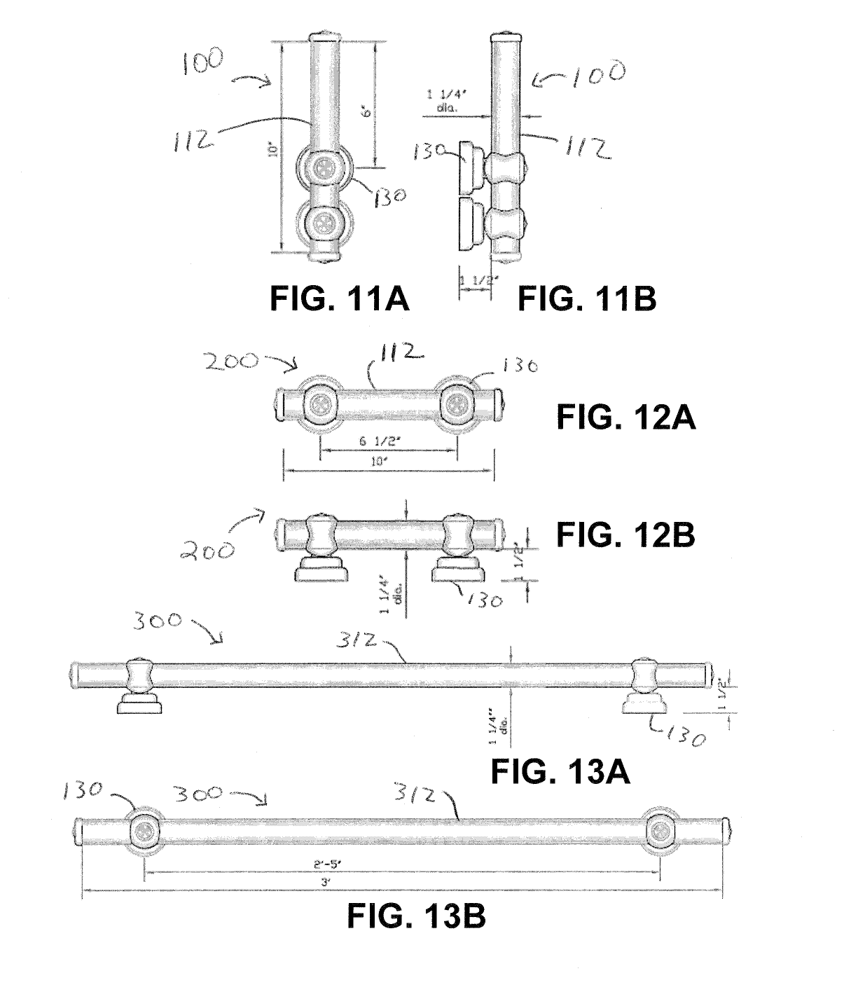

Aside from the embodiments of bar assembly 10 illustrated in FIGS. 1-9, other embodiments for bar assemblies are illustrated in FIGS. 11-15. FIGS. 11A-11B illustrate a shorter bar assembly 100 that includes a shorter bar 112 and fixtures 130 that are shorter than fixtures 30. In this embodiment, the fixtures 130 are located adjacent to each other such that the device functions as a toilet paper holder. It is also contemplated that only one fixture 130 may be used.

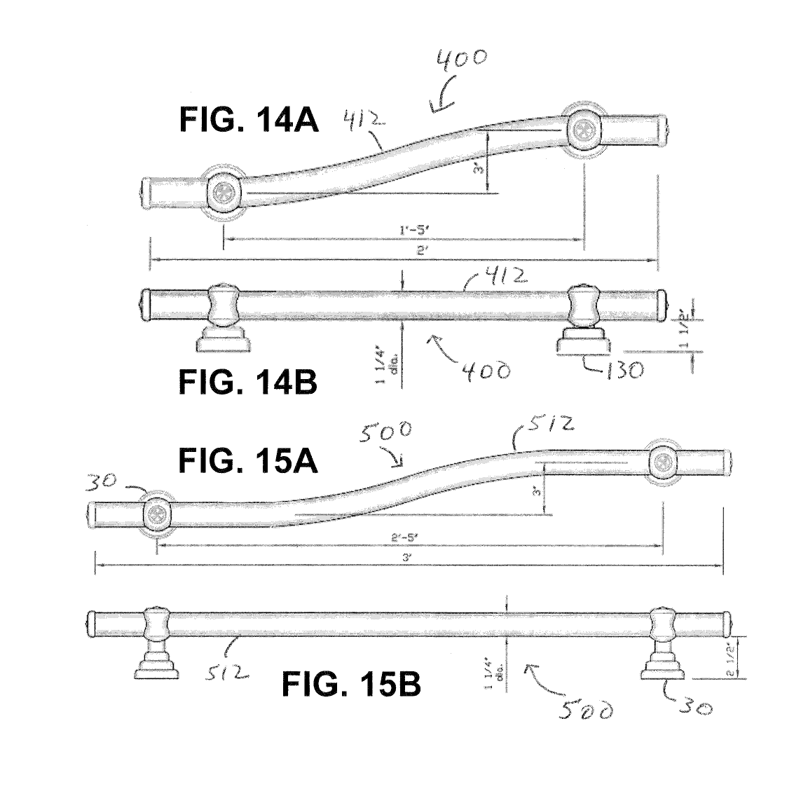

FIGS. 12A-12B also illustrate bar assembly 200 having a short bar 112 of, for example, ten inches, but the fixtures 130 are more conventionally spaced toward the ends of the bar 112. FIGS. 13A-13B illustrate a long bar 312 with shorter fixtures 130. Finally, FIGS. 14A-14B and FIGS. 15A-15B illustrate embodiments 400 and 500 that comprise curved bars 412 and 512, the difference between the two embodiments being the length of the bars 412, 512 and the height of the fixtures 30, 130.

This invention has been described with reference to illustrative embodiments and is not meant to be construed in a limiting sense. It will be apparent to one skilled in the art that elements or process steps from one or more embodiments described herein may be used in combination with elements or process steps from one or more other embodiments described herein, and that the present invention is not limited to the specific embodiments provided herein but only as set forth in the accompanying claims. Various modifications of the illustrative embodiments, as well as additional embodiments to the invention will be apparent to persons skilled in the art upon reference to this description.

What is claimed is:

1. A combination grab or article support bar and light source, comprising:
an elongated bar body, wherein the bar body is translucent or transparent;
means for attaching the bar body to a wall; and,
means for lighting at least partially located within the bar body.

2. The device of claim 1, wherein the means for lighting is a fiber optic light system, the light capable of transmission through the bar body.

3. The device of claim 2, wherein the fiber optic light source is located in a location other than an interior of the bar body.

4. The device of claim 3, wherein the means for attaching the bar body to the wall at least partially comprises a fixture having a bar body-receiving aperture therethrough.

5. The device of claim 4, wherein the fixture further comprises a base portion having an aperture therethrough that is in communication with the bar body-receiving aperture.

6. The device of claim 5, wherein a bottom of the base portion is attached to a mounting plate.

7. The device of claim 6, wherein the mounting plate has a central aperture therethrough.

8. The device of claim 7, wherein optic cables extend from the light source, through the central aperture in the mounting plate, through the aperture in the base portion of the fixture, and into an aperture in the bar.

9. The device of claim 1, wherein the means for lighting is an LED system, the light from the LED system capable of transmission through the bar body.

10. The device of claim 1, wherein the bar body further comprises end caps that are removably attached to ends of the bar body.

11. The device of claim 1, further comprising a switch for operating the means for lighting.

12. The device of claim 1, wherein the bar body is a curved.

13. The device of claim 1, wherein the device is a toilet paper holder.

14. The device of claim 1, wherein the device is a towel bar.

15. The device of claim 1, wherein the device is a grab bar.

16. A combination grab bar and light, comprising:
a translucent bar body; and,
a light source at least partially located within the bar body, wherein, the grab bar is capable of supporting the weight of a person.

17. A method of providing light for a room, comprising:
providing a support bar selected from the group consisting of grab bars, towel bars, and toilet paper holders; wherein the support bar is at least partially translucent or transparent; and
placing a light source at least partially inside the support bar such that light shines through the bar and provides light for the room.
